(19) United States
(12) Patent Application Publication
(10) Pub. No.: US 2026/0102986 A1
(43) Pub. Date: Apr. 16, 2026

(54) THREE-DIMENSIONAL BOTANICAL LEATHER FABRIC AND MANUFACTURING METHOD THEREOF

(71) Applicant: TAIWAN TEXTILE FEDERATION, R.O.C., Taipei City (TW)

(72) Inventors: Shu-Hui HUANG, Taipei City (TW); Hung-Kung CHIEN, Taipei City (TW); Yu-Han TSAI, Taipei City (TW)

(21) Appl. No.: 18/913,988

(22) Filed: Oct. 11, 2024

(51) Int. Cl. B32B 7/14; B32B 3/30; B32B 5/02; B32B 9/02; B32B 9/04; B32B 37/00; B32B 37/10; B32B 37/12; B32B 37/18; B32B 38/00

(52) U.S. Cl. CPC B32B 7/14; B32B 3/30; B32B 5/02; B32B 9/02; B32B 9/047; B32B 37/0076; B32B 37/10; B32B 37/1292; B32B 37/18; B32B 38/1875; B32B 2305/18; B32B 2307/51; B32B 2307/7376; B32B 2317/00

(57) ABSTRACT

Disclosed are a three-dimensional botanical leather fabric and a manufacturing method thereof. The three-dimensional botanical leather fabric includes an elastic fabric, an adhesive pattern layer and a botanical leather, the adhesive pattern layer is formed by coating an adhesive glue on a surface of the stretched elastic fabric, and the adhesive pattern layer has multiple spacings; the botanical leather is attached on the adhesive pattern layer and the elastic fabric when elastically restores to original state to drive the spacings to be shrunk, so that the botanical leather is formed with a flat fitting part attached to the adhesive pattern layer and a three-dimensional embossed pattern protruding to the outside with the shrinking of the spacings.

### BACKGROUND OF THE DISCLOSURE

### Technical Field

The present disclosure relates to a fabric structure and a manufacturing method thereof, particularly relates to a three-dimensional botanical leather fabric and a manufacturing method thereof.

### Description of Related Art

With the increasing awareness of environmental protection, due to the chemical substances used in the production of animal leather have caused serious pollution to the environment and the rise of animal protectionism, botanical leather with biodegradability has emerged on the market to replace the traditional animal leather.

The production process of botanical leather usually includes the use of botanical fibers or by-products of waste crops, such as pineapple leaves, apple peels, grape pomace, mushroom mycelium, etc., which are specially treated to form a leather-like material, resulting in botanical leather that still has room for improvement in terms of structure and aesthetics.

However, modern fabric products pursue personalization and novel style, so how to make complex and obvious three-dimensional embossed patterns on botanical leather to improve the structure and aesthetics of the botanical leather, of which the three-dimensional embossed pattern has the effect of high elasticity restoration rate, easy to deform easily after stretching and washing, etc., is a major research and development subject for the textile industry.

In view of the deficiencies of the related art, the present discloser conducted researches based on the existing technologies and the application of theories, and finally developed a three-dimensional botanical leather fabric and a manufacturing method thereof in accordance with the present disclosure to overcome the deficiencies of the related art.

### SUMMARY OF THE DISCLOSURE

The disclosure provides a three-dimensional botanical leather fabric and a manufacturing method thereof, in which a botanical leather is attached on a stretched elastic fabric in advance, and after the elastic fabric restores to original state to drive the botanical leather to protrude out from a three-dimensional embossed pattern, a three-dimensional botanical leather fabric with the advantages of high process yield, improved dimensionality and good elastic recovery may be achieved.

In some embodiments of the present disclosure, the present disclosure provides a three-dimensional botanical leather fabric, including: an elastic fabric; an adhesive pattern layer, formed by coating an adhesive glue on a surface of the stretched elastic fabric by a printing method, wherein the adhesive pattern layer has a plurality of spacings; and a botanical leather, attached on the adhesive pattern layer, and the elastic fabric when elastically stores to original state to drive the plurality of spacings to be shrunk, so as to form a flat fitting part of the botanical leather that fits on the adhesive pattern layer and a three-dimensional embossed pattern that protrudes with the shrinking of the plurality of spacings.

In some embodiments of the present disclosure, the present disclosure provides a manufacturing method of the three-dimensional botanical leather fabric, including the steps of: (A) providing a stretching tool and an elastic fabric to stretch the elastic fabric by the stretching tool; (B) providing an adhesive glue to be coated on the surface of the stretched elastic fabric to form an adhesive pattern layer, wherein the adhesive pattern layer includes a plurality of spacings; (C) providing a botanical leather to be attached on the adhesive pattern layer; and (D) removing the stretching tool, waiting the elastic fabric to elastically restore to original state, and driving the plurality of spacings to be shrunk, so as to form the botanical leather with a flat fitting part fitted on the adhesive pattern layer and a three-dimensional embossed pattern protruding with the shrinking of the plurality of spacings.

Based on the above, the elastic restoration of the elastic fabric to its original state will drive the botanical leather to protrude to the outside from the three-dimensional embossed pattern, that is, the three-dimensional embossed pattern is formed on the botanical leather without any indentations, seams and flaws, and the three-dimensional embossed pattern after deformed by tension will restore its original state with the elasticity of the elastic fabric, so as to achieve the three-dimensional botanical leather fabric with the advantages of high process yield, improved three-dimensionality and aesthetics, desirable elasticity restoration rate, and desirable biodegradability and environmental protection.

### BRIEF DESCRIPTION OF THE DRAWINGS

FIG. 1 is a flow chart showing a manufacturing method of a three-dimensional botanical leather fabric in accordance with the present disclosure.

FIG. 2 is a perspective view showing an adhesive glue to be coated on the surface of a stretched elastic fabric by a printing method in accordance with the present disclosure.

FIG. 3 is a perspective view showing a botanical leather to be attached on an adhesive pattern layer of the present disclosure.

FIG. 4 is a cross-sectional view showing the botanical leather to be attached on the adhesive pattern layer of the present disclosure.

FIG. 5 is a cross-sectional view showing the lamination of the elastic fabric, the adhesive pattern layer and the botanical leather of the present disclosure.

FIG. 6 is a cross-sectional view of the three-dimensional botanical leather fabric of the present disclosure.

FIG. 7 is a cross-sectional view of the three-dimensional botanical leather fabric in accordance with an embodiment of the present disclosure.

FIG. 8 is a top view of the three-dimensional botanical leather fabric in accordance with another embodiment of the present disclosure.

FIG. 9 is a top view of the three-dimensional botanical leather fabric in accordance with a further embodiment of the present disclosure.

### DETAILED DESCRIPTION

The detailed description and technical contents of the present disclosure are illustrated with reference to the accompanying drawings, which are intended for the illustrative purposes only, but not intended for limiting the disclosure.

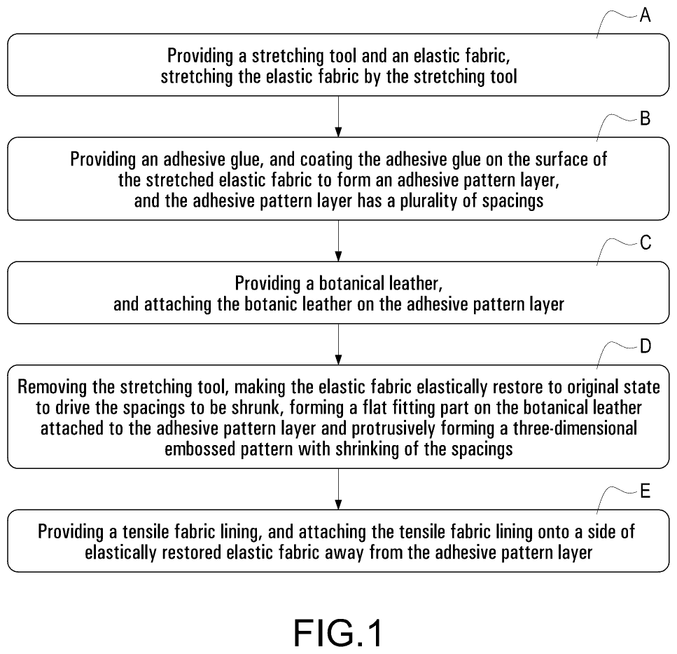

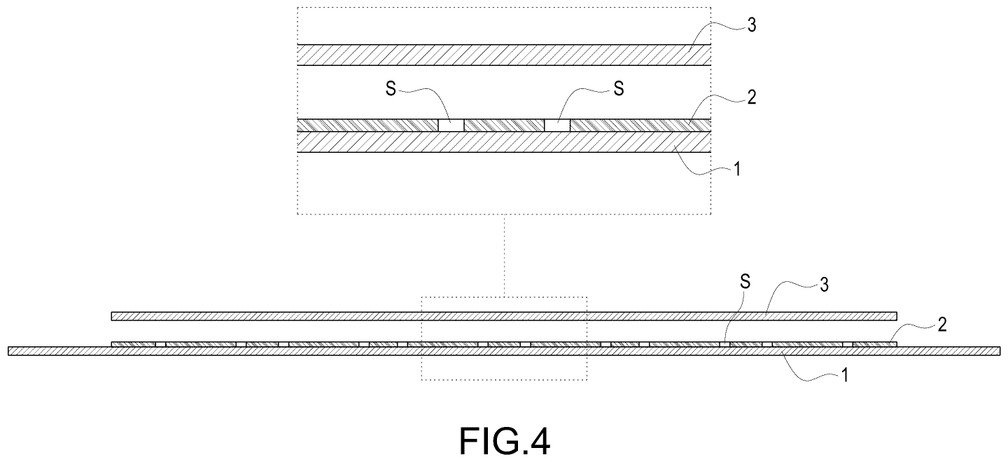

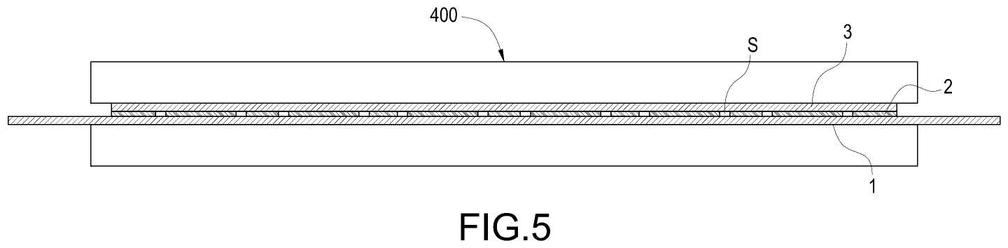

With reference to FIGS. 1 to 6 for a three-dimensional botanical leather fabric and a manufacturing method thereof in accordance with the present disclosure, the present disclosure provides a three-dimensional botanical leather fabric 10 mainly including an elastic fabric 1, an adhesive pattern layer 2 and a botanical leather 3.

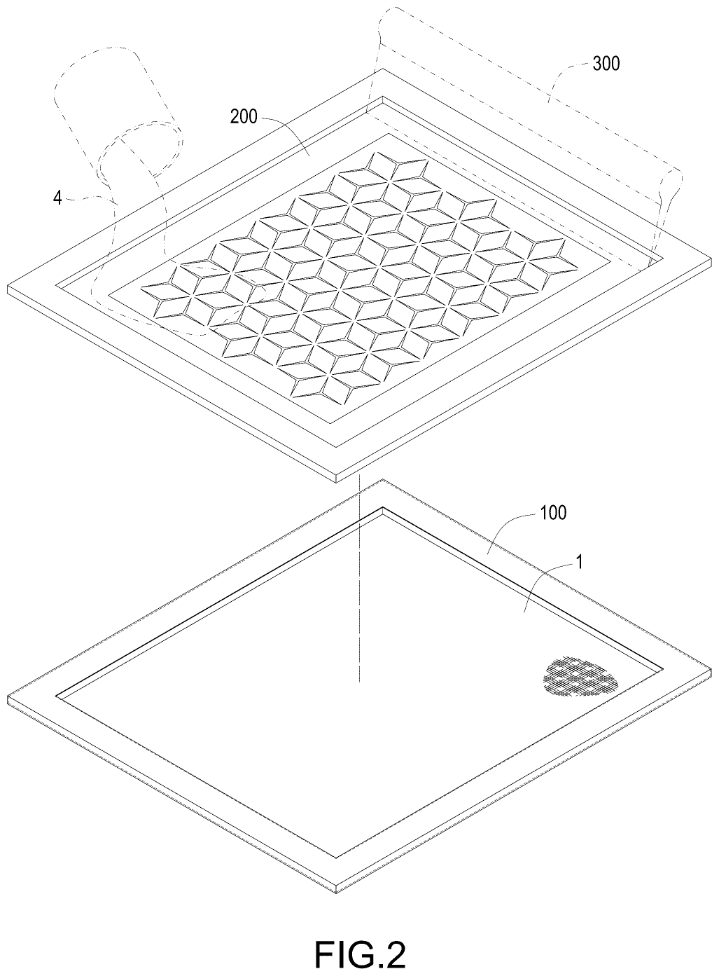

With reference to FIG. 1 for the steps of the manufacturing method of a three-dimensional botanical leather fabric 10 of the present disclosure, in the Step (A) as shown in FIGS. 1 and 2, a stretching tool 100 and an elastic fabric 1 are provided, and the elastic fabric 1 is stretched by the stretching tool 100.

In an embodiment, the elastic elongation of the elastic fabric 1 ranges from 10% to 20%, that is, the length of the elastic fabric 1 when not stretched is defined as an original length, and the length of the elastic fabric when being stretched longitudinally and transversely by the stretching tool is equal to 110% to 120% of the original length. The thickness of botanical leather 3 ranges from 0.1 to 1.5 mm.

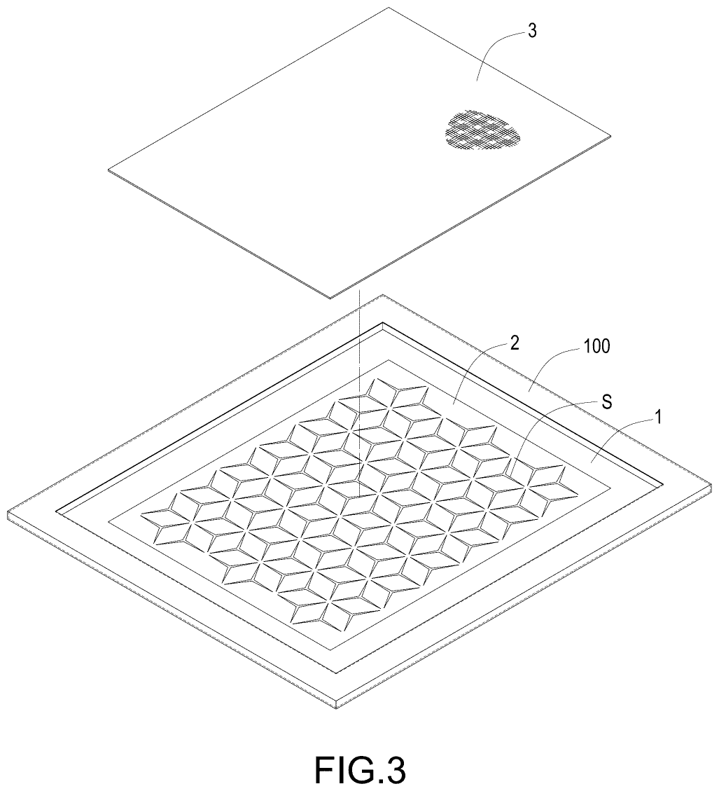

In the Step (B) as shown in FIG. 1, and FIGS. 2 and 3, an adhesive glue 4 is provided and coated onto a surface of the elastic fabric 1 to form an adhesive pattern layer 2, and the adhesive pattern layer 2 has a plurality of spacings S. The adhesive glue 4 is a solvent-based pressure sensitive adhesive, a water-based pressure sensitive adhesive, a heat curing pressure sensitive adhesive, etc.

In this embodiment, the adhesive glue 4 is scraped flatly by a scraper 300 to form an adhesive pattern layer 2 which is coated onto a surface of the stretched elastic fabric 1 through a screen printing method of a silk screen 200. The mesh number of the silk screen 200 is 100˜150, but it is not limited to this number. The adhesive pattern layer 2 is coated on the surface of the stretched elastic fabric 1 using an offset printing, letterpress printing or digital printing method.

In addition, the thickness of the adhesive pattern layer 2 falls within a range from 0.05 mm to 0.2 mm, the diameter of each spacing S falls within a range from 1 mm to 30 mm, and the adhesive pattern layer 2 is a point, a line or a plane of a geometric shape or any of their combinations.

In the Step (C) as shown in FIG. 1 and FIGS. 3 to 5, a botanical leather 3 is provided, a pressing operation of the elastic fabric 1, the adhesive pattern layer 2 and the botanical leather 3 is performed, and botanical leather 3 is attached onto the adhesive pattern layer 2 by a compression bonding manner or a hot press bonding manner.

Wherein, the botanical leather 3 is made of botanical fibers or by-products of waste crops, such as pineapple leaves, apple peels, grape pomace, mushroom mycelium, etc., which are specially treated to form a leather-like material, making the botanical leather 3 have desirable biodegradability, and environmental protection.

In the hot press bonding manner, the elastic fabric 1, the adhesive pattern layer 2 and the botanical leather 3 are hot pressed at the conditions of a pressure from 4 kg/cm² to 10 kg/cm², a hot press time from 5 sec to 30 sec, and a hot press temperature from 90° C. to 120° C., such that the adhesive pattern layer 2 melts when exposed to heat and slightly penetrates into the botanical leather 3 and the inner surface of the stretched elastic fabric 1, making the botanical leather 3, the adhesive pattern layer 2 and the stretched elastic fabric 1 closely adhere to each other.

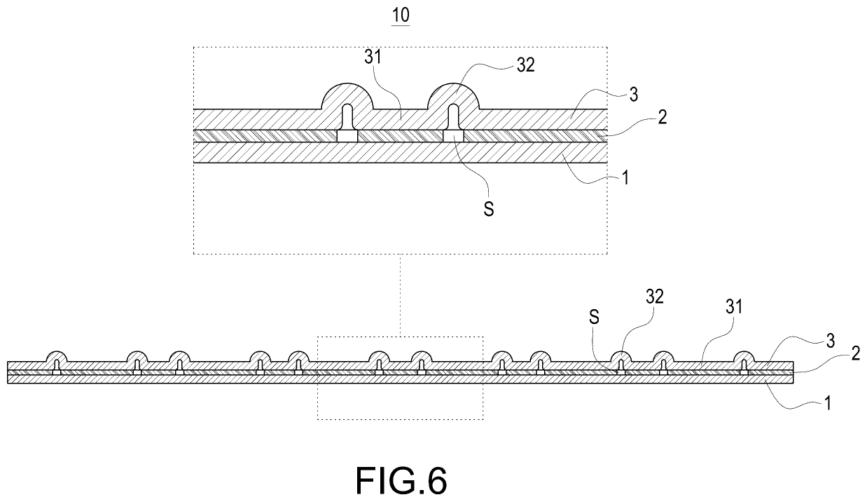

In the Step (D) as shown in FIG. 1 and FIG. 6, the stretching tool 100 is removed, the elastic fabric 1 after restoring to original state will drive the plurality of spacings S to be shrunk, that is, the stretched elastic fabric 1 when restoring to original state will drive the plurality of spacings S to be shrunk, so that the botanical leather 3 forms a flat fitting part 31 attached to the adhesive pattern layer 2 and a three-dimensional embossed pattern 32 protruding to the outside with the shrinking of the plurality of spacings S.

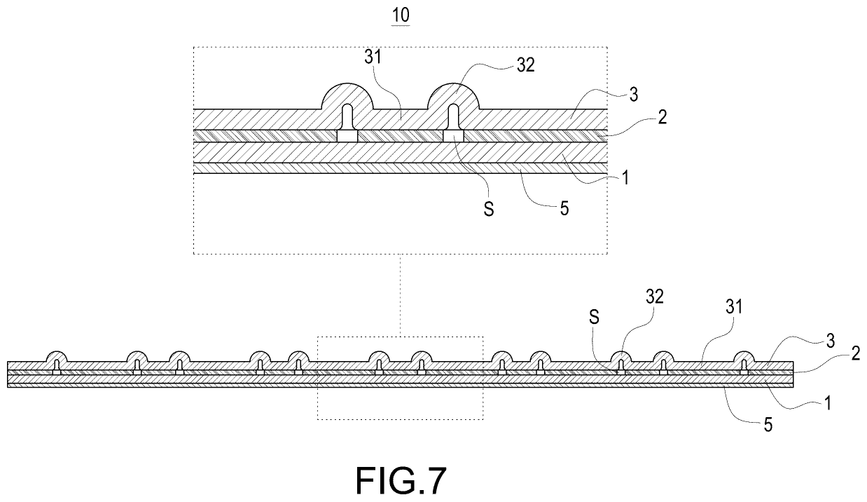

In the Step (E) as shown in FIG. 1 and FIG. 7, a tensile fabric lining 5 is provided, a surface of the tensile fabric lining 5 is coated with an adhesive glue or a laminating film in form of a point, a line or a plane to attach the tensile fabric lining 5 onto a surface of elastically restored elastic fabric 1 away from the adhesive pattern layer 2 through the adhesive glue or the laminating film, and the tensile fabric lining 5 is a woven fabric, a knitted fabric or a non-woven fabric.

With reference to FIG. 6 for the three-dimensional botanical leather fabric 10 in accordance with an embodiment of the present disclosure, the three-dimensional botanical leather fabric 10 contains the botanical leather 3, the adhesive pattern layer 2, and the elastic fabric 1 sequentially layered from top to bottom, which is a finished product shipped to customers. With reference to FIG. 7 for the three-dimensional botanical leather fabric 10 in accordance with another embodiment of the present disclosure, the three-dimensional botanical leather fabric 10 contains the botanical leather 3, the adhesive pattern layer 2, and the elastic fabric 1 sequentially layered from top to bottom. The tensile fabric lining 5 is a finished product shipped to customers, and the tensile fabric lining 5 is inelastic that prevents the three-dimensional botanical leather fabric 10 from being stretched, and improves the dimensional stability and durability of the three-dimensional botanical leather fabric 10.

In this way, the botanical leather 3 is first attached to the stretched elastic fabric 1, and when the elastic fabric 1 when elastically restoring to original state, the botanical leather 3 will protrude to the outside from the three-dimensional embossed pattern 32, and then the botanical leather 3 is attached to the stretched elastic fabric 1. A three-dimensional embossed pattern 32 is formed without any indentations, seams and flaws, and after being deformed by tension, the three-dimensional embossed pattern 32 will elastically restore to original shape with the elastic fabric 1, so as to achieve the three-dimensional botanical leather fabric 10 with desirable manufacturing process and the advantages of high efficiency, improved three-dimensional effect and aesthetics, desirable elastic restoration rate, and desirable biodegradability and environmental protection.

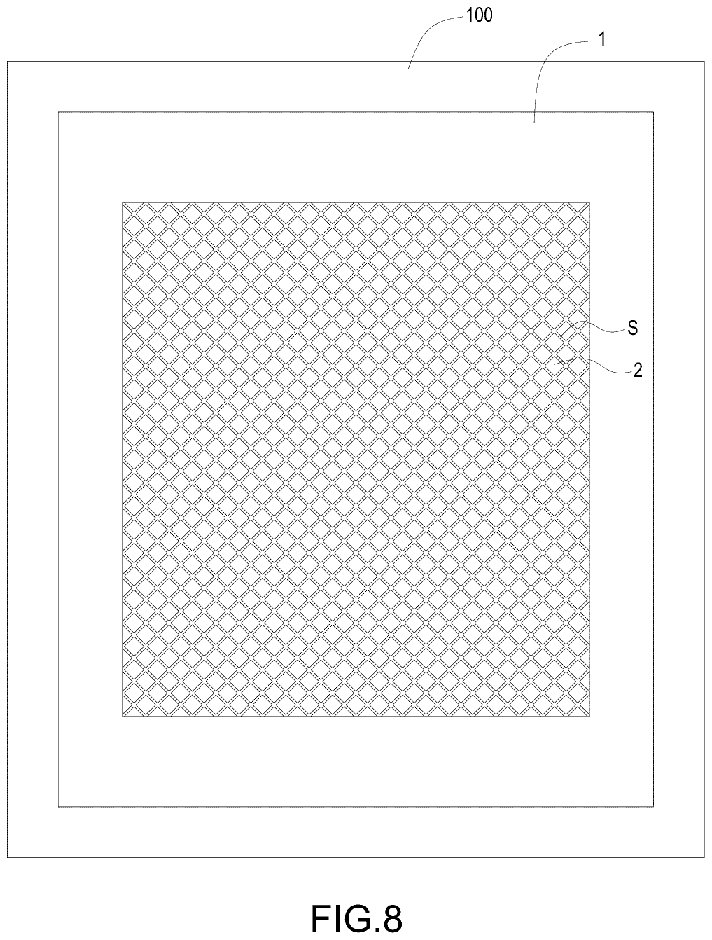

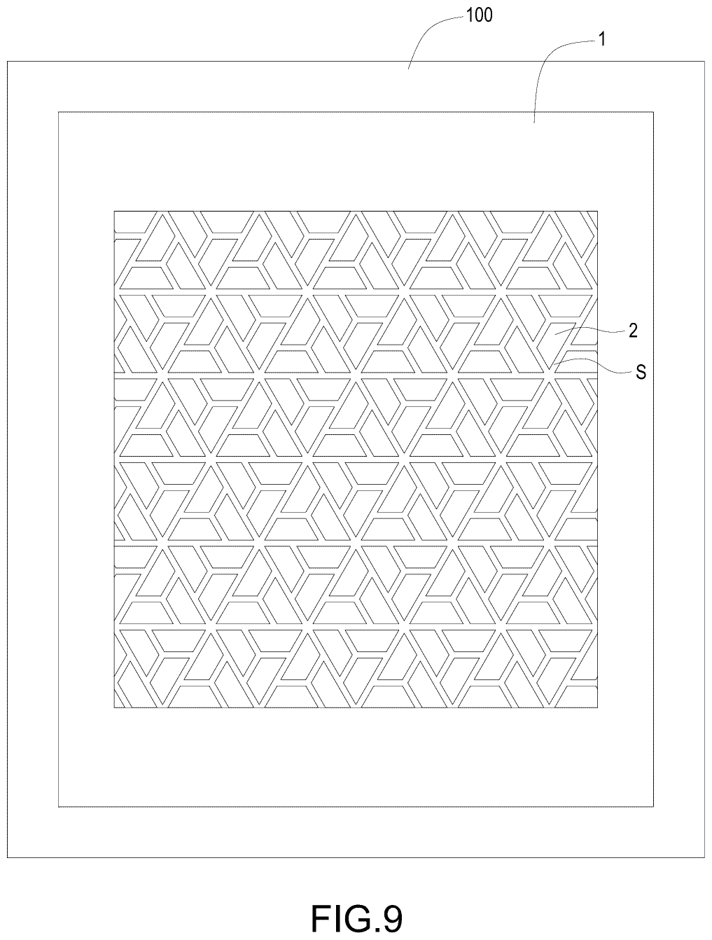

With reference to FIGS. 8 and 9 for the adhesive pattern layer 2 in accordance with a further embodiment of the present disclosure, this embodiment is substantially the same as the embodiment illustrated in FIG. 3, except that the pattern design of the adhesive pattern layer 2 is different, the adhesive pattern layer 2 of FIG. 3 is constructed by a plurality of rhombic planes arranged side by side with each other, and the adhesive pattern layer 2 of FIG. 8 is constructed by a plurality of rhombic points arranged side by side with each other, and the adhesive pattern layer 2 of FIG. 9 is constructed by triangles and trapezoid which are formed by a plurality of rhombic lines interlaced with each other, but the present disclosure is not limited to such arrangement only, and the adhesive pattern layer 2 may be a point, a line, a plane of a geometric shape or any of their combinations.

While this disclosure has been described by means of specific embodiments, numerous modifications and variations may be made thereto by those skilled in the art without departing from the scope and spirit of this disclosure set forth in the claims.

What is claimed is:

1. A three-dimensional botanical leather fabric, comprising:
an elastic fabric;
an adhesive pattern layer, formed by coating an adhesive glue on a surface of the elastic fabric being stretched, and comprising a plurality of spacings; and
a botanical leather, attached on the adhesive pattern layer, wherein when the elastic fabric restores to an original state to drive the plurality of spacings to be shrunk, a flat fitting part, that attached to the adhesive pattern layer, is formed on the botanical leather and a three-dimensional embossed pattern is formed protrusively on the botanical leather with the shrinking of the plurality of spacings.

2. The three-dimensional botanical leather fabric of claim 1, further comprising a tensile fabric lining attached on a side of the elastic fabric, which is elastically restored to the original state, away from the adhesive pattern layer, wherein the tensile fabric lining is a woven fabric, a knitted fabric, or a non-woven fabric.

3. The three-dimensional botanical leather fabric of claim 1, wherein the thickness of the botanical leather ranges from 0.1 mm to 1.5 mm, the thickness of the adhesive pattern layer ranges from 0.05 mm to 0.2 mm, and the elastic elongation of the elastic fabric ranges from 10% to 20%.

4. The three-dimensional botanical leather fabric of claim 1, wherein the adhesive pattern layer is a point, a line, a plane of a geometric shape or a combination thereof, and the size of each spacing ranges from 1 mm to 30 mm.

5. The three-dimensional botanical leather fabric of claim 1, wherein the adhesive pattern layer is coated on the surface of the elastic fabric being stretched by a screen printing method, an offset printing method, a letterpress printing method or a digital printing method.

6. A manufacturing method of a three-dimensional botanical leather fabric, the manufacturing method comprising:
(A)providing a stretching tool and an elastic fabric, and stretching the elastic fabric by the stretching tool;
(B)providing an adhesive glue, and coating the adhesive glue on a surface of the elastic fabric being stretched to form an adhesive pattern layer, wherein the adhesive pattern layer comprises a plurality of spacings;
(C)providing a botanical leather, attaching the botanical leather on the adhesive pattern layer; and
(D)removing the stretching tool, waiting the elastic fabric to elastically restore to an original state to drive the plurality of spacings to be shrunk, and forming a flat fitting part on the botanical leather attached to the adhesive pattern layer and protrusively forming a three-dimensional embossed pattern with shrinking of the plurality of spacings.

7. The manufacturing method according to claim 6, further comprising (E) providing a tensile fabric lining, and attaching the tensile fabric lining on a side of the elastic fabric, which is elastically restored, away from the adhesive pattern layer.

8. The manufacturing method according to claim 6, wherein in the (A), a length of the elastic fabric before being stretched is defined as an original length, and the elastic fabric is stretched by the stretching tool to 110% to 120% of the original length longitudinally and transversely.

9. The manufacturing method according to claim 6, wherein in the (B), the adhesive pattern layer is coated on the surface of the elastic fabric being stretched by a screen printing method, an offset printing method, a letterpress printing method or a digital printing method.

10. The manufacturing method according to claim 6, wherein in the (C), performing a pressing operation to the elastic fabric, the adhesive pattern layer and the botanical leather to attach the botanical leather onto the adhesive pattern layer by a compression bonding manner or a hot-press bonding manner.
